(19) United States
(12) Patent Application Publication
(10) Pub. No.: US 2025/0105545 A1
(43) Pub. Date: Mar. 27, 2025

(54) HEADER CONNECTOR WITH BUSBAR ASSEMBLY

(71) Applicant: TE Connectivity Solutions GmbH, Schaffhausen (CH)

(72) Inventor: Thomas Robert DeWitte, Shelby Township, MI (US)

(21) Appl. No.: 18/736,612

(22) Filed: Jun. 7, 2024

Related U.S. Application Data
(60) Provisional application No. 63/645,465, filed on May 10, 2024.
(60) Provisional application No. 63/540,178, filed on Sep. 25, 2023.

(51) Int. Cl. H01R 13/506; H01R 13/04; H01R 13/41; H01R 13/508

(52) U.S. Cl. CPC H01R 13/506; H01R 13/04; H01R 13/41; H01R 13/508

(57) ABSTRACT

A header connector includes a header housing extending between a mating end and a terminating end. The mating end is configured to be mated with a plug connector. The header housing has a cavity between the mating end and the terminating end. The header housing has a mounting flange configured to be mounted to a panel. The header connector includes a busbar carrier assembly that includes a busbar carrier and a busbar held by the busbar carrier. The busbar carrier has a support wall and a mounting portion. The busbar is coupled to the support wall. The mounting portion is coupled to the terminating end of the header housing. The busbar is received in the cavity of the header housing for mating with the plug connector when the mounting portion of the busbar carrier is coupled to the terminating end of the header housing.

### CROSS REFERENCE TO RELATED APPLICATIONS

This application claims benefit to U.S. Application No. 63/645,465, filed 10 May 2024, titled “HEADER CONNECTOR WITH BUSBAR ASSEMBLY” and U.S. Application No. 63/540,178, filed 25 Sep. 2023, titled “HEADER WITH SEPARABLE BUS BAR CARRIER” the subject matter of which are herein incorporated by reference in their entirety.

### BACKGROUND OF THE INVENTION

The subject matter herein relates generally to header connectors.

Communication systems include electrical connectors, which are mated to electrically connect various components of the system. For example, a header connector may be mounted to a device, such as to a chassis, a panel, a circuit board, or another substrate, for mating with a plug connector. The plug connector may be terminated to a wire harness or another circuit board. The header connector typically includes a housing holding terminals or busbars, which are configured to be terminated to cables. The busbars are typically individually loaded into the header housing, which increases the number of components needed to be installed and assembled by the customer, which increases the assembly cost and complexity. During assembly, the header connector is typically loaded through an opening in the device (for example, a panel opening). The opening has a certain shape/size, known as a feed envelope, to feed the header connector through during assembly. The size of the header connector is limited by the size of the feed envelope to fit through the opening. The sizes and shapes of the busbars are limited by the size/shape of the feed envelope because the busbars need to pass through the opening.

A need remains for a header connector that may be assembled and installed in a cost effective and reliable manner.

### BRIEF DESCRIPTION OF THE INVENTION

In one embodiment, a header connector is provided and includes a header housing extending between a mating end and a terminating end. The mating end is configured to be mated with a plug connector. The header housing has a cavity between the mating end and the terminating end. The header housing has a mounting flange configured to be mounted to a panel. The header connector includes a busbar carrier assembly that includes a busbar carrier and a busbar held by the busbar carrier. The busbar carrier has a support wall and a mounting portion. The busbar is coupled to the support wall. The mounting portion is coupled to the terminating end of the header housing. The busbar is received in the cavity of the header housing for mating with the plug connector when the mounting portion of the busbar carrier is coupled to the terminating end of the header housing.

In another embodiment, a header connector is provided and includes a header housing extending between a front and a rear. The header housing includes a mating end at the front and a terminating end at the rear. The mating end is configured to be mated with a plug connector. The header housing has a cavity between the mating end and the terminating end. The header housing has a mounting flange configured to be mounted to a front surface of a panel with a portion of the header housing passing through a panel opening in the panel rearward of a rear surface of the panel. The header connector includes a busbar carrier assembly that includes a busbar carrier and a busbar held by the busbar carrier. The busbar carrier has a support wall and a mounting portion. The busbar is coupled to the support wall. The mounting portion is coupled to the terminating end of the header housing rearward of the panel. The busbar is received in the cavity of the header housing for mating with the plug connector when the mounting portion of the busbar carrier is coupled to the terminating end of the header housing.

In a further embodiment, a header connector for mounting to a panel has a panel opening to define a feed envelope is provided. The header connector includes a header housing extending between a mating end and a terminating end. The mating end is configured to be mated with a plug connector. The header housing has a cavity between the mating end and the terminating end. The header housing has a mounting flange configured to be mounted to a panel. The mounting flange is dimensioned larger than the feed envelope in at least one direction. The header connector includes a busbar carrier assembly that includes a busbar carrier and a busbar hold by the busbar carrier. The busbar carrier has a support wall and a mounting portion. The mounting portion is coupled to the terminating end of the header housing. The busbar is coupled to the support wall. The busbar has a mating end and a terminating end configured to be terminated to a power cable. The mating end is dimensioned to fit within the feed envelope. The terminating end is dimensioned larger than the feed envelope in at least one direction. The mating end of the busbar is received in the cavity of the header housing for mating with the plug connector when the mounting portion of the busbar carrier is coupled to the terminating end of the header housing.

### BRIEF DESCRIPTION OF THE DRAWINGS

FIG. 1 is a perspective view of a communication system in accordance with an exemplary embodiment.

FIG. 2 is an exploded view of the header connector in accordance with an exemplary embodiment.

FIG. 3 is a front perspective view of the busbar carrier assembly in an assembled state in accordance with an exemplary embodiment.

FIG. 4 is a sectional view of the busbar carrier assembly in accordance with an exemplary embodiment.

FIG. 5 is an exploded view of the header connector in accordance with an exemplary embodiment showing the busbar carrier assembly poised for coupling to the header housing.

FIG. 6 is a side view of the header connector in accordance with an exemplary embodiment showing the busbar carrier assembly poised for coupling to the header housing.

FIG. 7 is a rear perspective view of the header connector in accordance with an exemplary embodiment showing the busbar carrier assembly poised for coupling to the header housing.

FIG. 8 shows the terminating ends of the busbars having different shapes in accordance with an exemplary embodiment.

### DETAILED DESCRIPTION OF THE INVENTION

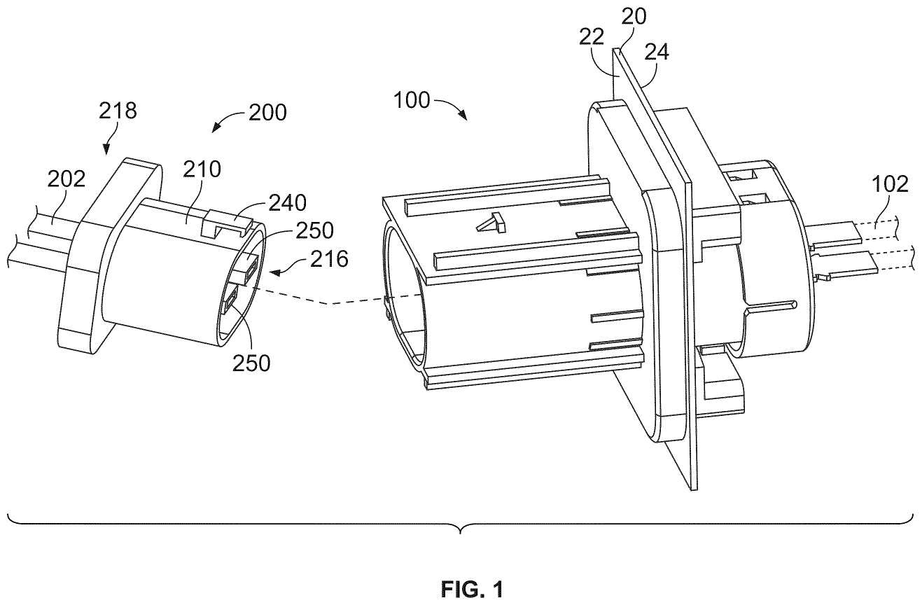

FIG. 1 is a perspective view of a communication system 10 in accordance with an exemplary embodiment. The communication system 10 includes a first electrical connector 100 and a second electrical connector 200 configured to be mated with the first electrical connector 100. The communication system 10 may include a plurality of the electrical connectors 100 and/or a plurality of the electrical connectors 200. The electrical connector 200 is a mating electrical connectors for the first electrical connector 100. Similarly, the first electrical connector 100 is considered a mating electrical connector for the second electrical connectors 200.

In an exemplary embodiment, the first electrical connector 100 is a header connector and may be referred to hereinafter as header connector 100. The header connector 100 is mounted to a component or device, such as a panel 20. The panel 20 of the device is used to hold the header connector 100. The header connector 100 may be mounted to other components, such as a chassis, a wall, a circuit board, or another type of substrate. In an exemplary embodiment, the header connector 100 is a power connector provided at ends of power cables 102. In the illustrated embodiment, the header connector 100 is a straight pass-through connector having the cables extend in a direction parallel to the mating direction with the second electrical connector 200. Other orientations are possible in alternative embodiments, such as a right angle connector. In other various embodiments, the header connector 100 may be a board mounted connector configured to be mounted to a circuit board.

In an exemplary embodiment, the second electrical connector 200 is a plug connector and may be referred to hereinafter as plug connector 200. The plug connector 200 is configured to be plugged into a receptacle or socket of the header connector 100. In an exemplary embodiment, the plug connector 200 is a cable connector provided at an end of one or more cables 202. In the illustrated embodiment, the cables 202 extend from an end opposite the mating end of the plug connector 200. In other various embodiments, the plug connector 200 may be a right angle connector having the cables 202 extend perpendicular to the mating end. In other various embodiments, the plug connector 200 may be a board mounted connector configured to be mounted to a circuit board.

The plug connector 200 includes a plug housing 210 holding a plurality of plug contacts 250. The plug connector 200 includes a plug latch 240 having a latching element used to latchably couple the plug connector 200 to the plug connector 200. In an exemplary embodiment, the plug housing 210 is manufactured from a dielectric material. For example, the plug housing 210 may be molded from a plastic material. The plug housing 210 extends between a mating end 216 and a cable end 218. The mating end 216 is configured to be plugged into the header housing 110. The cables 202 extend from the cable end 218. In an exemplary embodiment, the plug contacts 250 are power contacts. The plug contacts 250 may be socket contacts configured to receive mating ends of the header contacts of the header connector 100. Other types of contacts may be provided in alternative embodiments, such as blade contacts, pin contacts, spring beam contacts, busbars, and the like. The plug contacts 250 are terminated to the corresponding cables 202. For example, the plug contacts 250 may be welded or crimped to the cables 202. The cables 202 may be power cables.

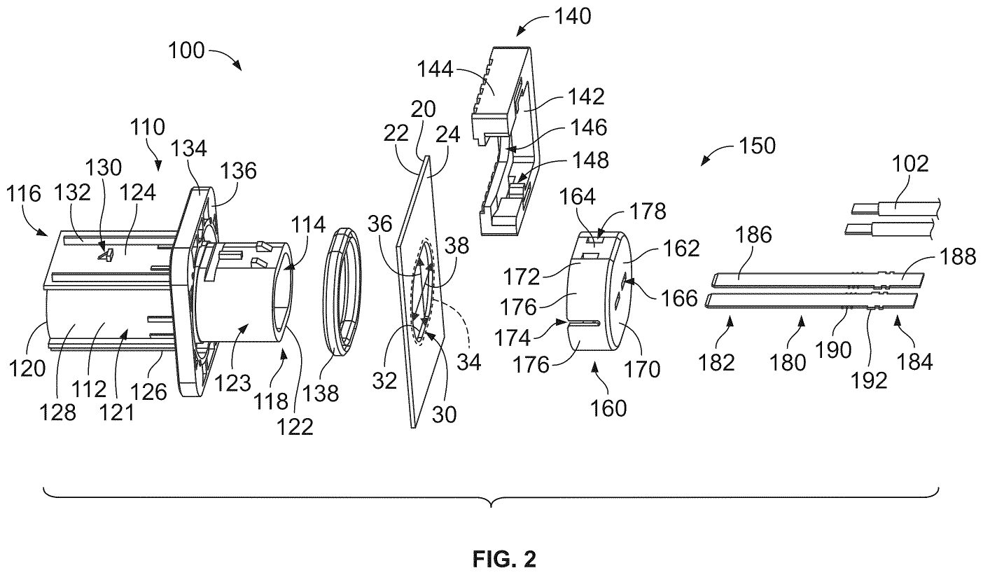

The panel 20 provides a rigid supporting structure to support the header connector 100. In an exemplary embodiment, the panel 20 is a metal sheet. However, the panel 20 may be manufactured from other materials and construction methods. The panel 20 has a front surface 22 and a rear surface 24. The panel 20 has a thickness between the front surface 22 and the rear surface 24. The front surface 22 may face outward, such as to an exterior of the device, and the rear surface 24 may face inward, such as to an interior portion of the device. In an exemplary embodiment, the panel 20 includes a panel opening 30 (shown in FIG. 2) that receives the header connector 100. In an exemplary embodiment, the header connector 100 is front loaded into the panel opening 30 and mated to the front surface 22. The header housing 110 is sized and shaped to fit through the panel opening 30 during assembly. A portion of the header housing 110 is accessible forward of the panel 20 to mate with the plug connector 200. In an exemplary embodiment, the power cables 102 are located behind the panel 20, such as at the interior of the device.

FIG. 2 is an exploded view of the header connector 100 in accordance with an exemplary embodiment. The header connector 100 is shown relative to the panel 20. FIG. 2 shows the panel opening 30 through the panel 20. The panel opening 30 is defined by an edge 32. In the illustrated embodiment, the panel opening 30 is oval shaped. However, the panel opening 30 may have other shapes in alternative embodiments. The shape of the panel opening 30 may correspond to an exterior shape of the header connector 100.

The size and shape of the panel opening 30 defines a feed envelope 34 through the plane of the panel 20. The feed envelope 34 is a window allowing the header connector 100 to pass through the panel 20. The feed envelope 34 defines the boundaries (for example, size/shape) for allowing portions of the header connector 100 to pass through the panel 20. The feed envelope 34 has a height 36 and a width 38. The width 38 may be greater than the height 36. The feed envelope 34 is oval shaped in the illustrated embodiment. However, the feed envelope 34 may have other shapes in alternative embodiments.

The header connector 100 includes a header housing 110 and a busbar carrier assembly 150 coupled to the header housing 110. The busbar carrier assembly 150 includes a busbar carrier 160 holding a plurality of busbars 180. The busbar carrier assembly 150 is removably coupled to the header housing 110. The busbar carrier assembly 150 allows coupling of a plurality of busbars 180 to the header housing 110 as a unit in a single assembly process rather than individual the coupling the busbars 180 to the header housing 110. In an exemplary embodiment, the busbar carrier assembly 150 allows coupling of the busbars 180 to the header housing 110 from the rear (for example, from behind the panel 20) independent of coupling the header housing 110 to the panel 20. For example, the header housing 110 may be coupled to the front of the panel 20 and the busbar carrier assembly 150 may be coupled to the header housing 110 from the rear of the panel 20.

In an exemplary embodiment, the header housing 110 is manufactured from a dielectric material. For example, the header housing 110 may be molded from a plastic material. The header housing 110 includes a plurality of walls 112 forming a cavity 114 that receives the plug connector 200. The header housing 110 extends between a mating end 116 and a terminating end 118. The plug connector 200 is configured to be coupled to the mating end 116. The cavity 114 is open at the mating end 116 to receive the plug connector 200. In an exemplary embodiment, the busbar carrier assembly 150 is coupled to the terminating end 118. The busbars 180 and the power cables 102 terminated to the busbars 180 extend from the terminating end 118.

The header housing 110 includes a front 120 and a rear 122. In an exemplary embodiment, the header housing 110 includes a front portion 121 extending rearward from the front 120 and a rear portion 123 extending forward from the rear 122. The front portion 121 is provided at the mating end 116. The rear portion 123 is provided at the terminating end 118. The front portion 121 is configured to receive the plug connector 200. The rear portion 123 is configured to receive the busbar carrier assembly 150. The header housing 110 includes a top 124 and a bottom 126. The header housing 110 includes sides 128 between the top 124 and the bottom 126. The cavity 114 is open at the rear 122 to receive the busbars 180. The cavity 114 is open at the front 120 to receive the plug connector 200.

In an exemplary embodiment, a latch 130 is provided at the top 124 for latchably coupling the plug connector 200 to the header connector 100. For example, the latch 130 is located along an exterior surface of the top wall at the top 124 of the header housing 110. Other locations are possible in alternative embodiments.

In an exemplary embodiment, the header housing 110 includes guide features 132 to guide mating of the plug connector 200 with the header connector 100. The guide features 132 may be provided along the exterior and/or the interior of the walls 112. The guide features 132 may be tabs, rails, grooves, or other types of guide features. The guide features 132 may define keying features for keyed mating with particular plug connectors 200.

In an exemplary embodiment, the header housing 110 includes a mounting flange 134 extending from the exterior of the header housing 110. The front portion 121 extends forward from the mounting flange 134. The rear portion 123 extends rearward from the mounting flange 134. The rear portion 123 is configured to be loaded through the panel opening 30 during assembly. In the illustrated embodiment, the mounting flange 134 extends entirely around the header housing 110. For example, the mounting flange 134 extends from the top 124, the bottom 126, and both sides 128. However, the mounting flange 134 may extend from fewer sides of the header housing 110 in alternative embodiments. The mounting flange 134 is used to mount the header housing 110 to the panel 20. The mounting flange 134 includes a mounting surface 136. In the illustrated embodiment, the mounting surface 136 is rearward facing. The mounting surface 136 of the mounting flange 134 is configured to engage the front surface 22 of the panel 20. The mounting surface 136 may be generally planar to seat against the front surface 22 of the panel 20.

In an exemplary embodiment, a perimeter seal 138 may be coupled to the mounting flange 134. The perimeter seal 138 may extend around the perimeter of the header housing 110. The perimeter seal 138 is configured to seal against the header housing 110 and the panel 20. For example, the perimeter seal 138 may be received in a seal pocket in the mounting flange 134 to face the front surface 22 of the panel 20. The perimeter seal 138 may be compressed between the front surface 22 of the panel 20 and the mounting flange 134.

In an exemplary embodiment, the header connector 100 includes a slide lock 140 used to secure the header connector 100 to the panel 20. The slide lock 140 is configured to be coupled to the panel 20. For example, the slide lock 140 may be coupled to the rear surface 24 of the panel 20. The slide lock 140 is positioned relative to the mounting flange 134 to capture the panel 20 between the mounting flange 134 and the slide lock 140. In an exemplary embodiment, the slide lock 140 includes a base 142 and arms 144 extending from the base 142. The slide lock 140 forms a pocket 146 between the arms 144. The pocket 146 is configured to receive the rear portion 123 of the header housing 110. In an exemplary embodiment, the pocket 146 is open between the arms 144 at the side opposite the base 142. For example, the slide lock 140 may be C-shaped having an open side allowing side loading of the slide lock 140 onto the header housing 110. The slide lock 140 is configured to be coupled to the header housing 110 in a direction perpendicular to the longitudinal axis for the mating axis of the header connector 100. For example, the slide lock 140 may be side loaded onto the header housing 110. The slide lock 140 includes locking features 148 used to secure the slide lock 140 to the header housing 110. For example, the locking features 148 may be grooves, slots, openings, tabs, protrusions, detents, or other types of locking features 148. In the illustrated embodiment, the locking features 148 are slots formed in the arms 144 configured to receive protrusions 149 extending from the header housing 110, such as at the top 124 and/or the bottom 126. In alternative embodiments, the locking features 148 may include a deflectable latch. In other various embodiments, a fastener, such as a threaded fastener, may be used as the locking feature 148 2 secure the slide lock 140 to the header housing 110.

In an exemplary embodiment, the busbar carrier assembly 150 may be coupled to the header housing 110 after the header housing 110 is coupled to the panel 20. The busbar carrier assembly 150 may be coupled to the header housing 110 after the slide lock 140 is coupled to the header housing 110 to securely connect the header connector 100 to the panel 20. For example, the busbar carrier 160 is separate and discrete from the header housing 110. The busbar carrier 160 may be removably coupled to the rear portion 123 of the header housing 110. For example, latching features may be used to secure the busbar carrier 160 to the rear portion 123. The busbar carrier 160 may be removed from the rear portion 123 a releasing the latching features.

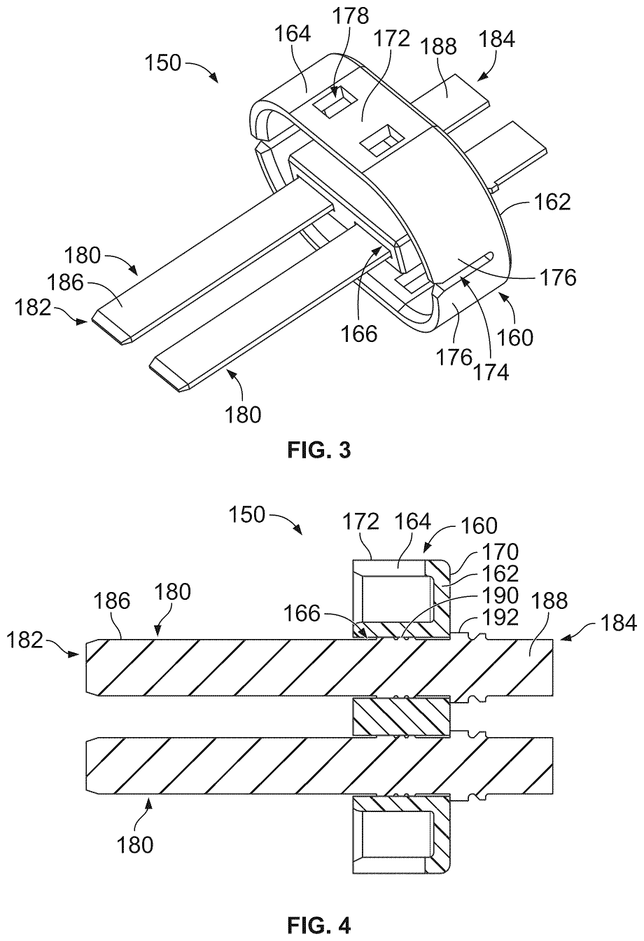

With additional reference to FIG. 3, which is a front perspective view of the busbar carrier assembly 150 in an assembled state, and to FIG. 4, which is a sectional view of the busbar carrier assembly 150, the busbar carrier assembly 150 includes the busbar carrier 160 and a plurality of the busbars 180. In the illustrated embodiment, the busbar carrier assembly 150 includes a pair of the busbars 180. The busbar carrier assembly 150 may include greater or fewer busbars 180 in alternative embodiments, such as four busbars 180. The busbars 180 may be aligned, such as in a plane. Alternatively, the busbars 180 may be arranged in another arrangement, such as in multiple rows. The busbars 180 may be oriented horizontally, such as parallel to each other. Alternatively, the busbars 180 may be at other orientations, such as perpendicular to each other.

The busbar carrier 160 includes a support wall 162 and a mounting portion 164 extending from the support wall 162. The support wall 162 includes busbar channels 166 passing through the support wall 162. The busbars 180 are configured be received in the corresponding busbar channels 166. The support wall 162 holds the relative positions of the busbars 180. The busbar channels 166 extend between the front and the rear of the support wall 162 allowing the busbars 180 to pass through the support wall 162. In an exemplary embodiment, the busbars 180 are held in the busbar channels 166, such as using retention barbs or other securing features, such as snap lock features, clips or fasteners. The busbars 180 may be stitched into the busbar channels 166, such as through the rear of the support wall 162. In other various embodiments, the busbar carrier 160 is overmolded over the busbars 180.

The mounting portion 164 extends from the support wall 162. In the illustrated embodiment, the mounting portion 164 extends entirely circumferentially around the support wall 162. For example, the mounting portion 164 may be located above, below, and at both sides of the support wall 162. The mounting portion 164 may have other shapes in alternative embodiments. For example, the mounting portion 164 may extend from the top and/or the bottom and/or the first side and/or the second side of the support wall 162. In the illustrated embodiment, the mounting portion 164 forms a ring around the support wall 162.

In an exemplary embodiment, the mounting portion 164 includes an end wall 170 and an outer wall 172. The end wall 170 extends between the support wall 162 and the outer wall 172. In an exemplary embodiment, the end wall 170 is located at the rear of the busbar carrier 160 and the outer wall 172 extends forward from the distal end of the end wall 170. The outer wall 172 forms the ring around the support wall 162. In an exemplary embodiment, the outer wall 172 includes slots 174 dividing the outer wall 172 into sections 176. The slots 174 allow the sections 176 to move relative to each other, such as for securing to the rear portion 123 of the header housing 110.

In an exemplary embodiment, the outer wall 172 of the mounting portion 164 includes latching features 178 configured to be latchably coupled to the header housing 110. In the illustrated embodiment, the latching features 178 are openings configured to receive latches extending from the rear portion 123 of the header housing 110. Other types of latching features may be used in alternative embodiments.

Each busbar 180 extends between a mating end 182 and a terminating end 184. The mating end 182 is configured to be connected to the plug connector 200. The terminating end 184 is configured to be connected to the power cable 102. In an exemplary embodiment, the busbar 180 is a stamped part. For example, the busbar 180 may be stamped from a sheet of metal. The busbar 180 may be generally planar. In the illustrated embodiment, the busbar 180 forms a blade 186 at the mating end 182 configured to be plugged into a socket of the plug contact 250 of the plug connector 200. Other types of contacts may be provided at the mating end 182, such as a pin, a socket, spring beams, or other type of contact. In an exemplary embodiment, the busbar 180 includes a tab 188 at the terminating end 184. The power cable 102 may be welded to the tab 188. In other embodiments, the tab 188 may include an opening configured to receive a fastener, such as a bolt used to connect the tab 188 to the power cable 102.

In an exemplary embodiment, the busbar 180 includes retention barbs 190 extending from the side edges of the busbar 180. The retention barbs 190 are configured to retain or secure the busbars 180 in the busbar channels 166. For example, the retention barbs 190 may dig into the plastic material of the support wall 162 to holds the busbar 180 in the busbar carrier 160. In an exemplary embodiment, the busbar 180 may include a load stop 192 extending from the side edges of the busbar 180. The load stop 192 is configured to engage the support wall 162. The load stop 192 positions the busbar 180 relative to the busbar carrier 160. For example, the busbar 180 may be rear loaded into the busbar channel 166 until the load stop 192 engages the rear surface of the support wall 162. The load stop 192 prevents forward loading of the busbar 180 once the load stop 192 is seated against the support wall 162. Other types of locating features may be used in alternative embodiments.

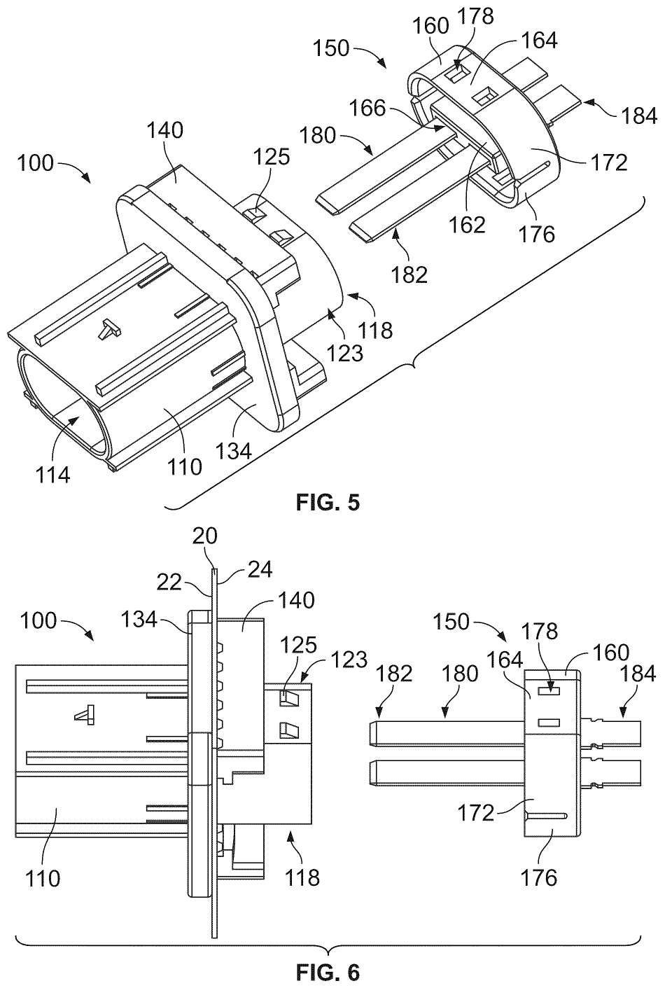

FIG. 5 is an exploded view of the header connector 100 in accordance with an exemplary embodiment showing the busbar carrier assembly 150 poised for coupling to the header housing 110. FIG. 6 is a side view of the header connector 100 in accordance with an exemplary embodiment showing the busbar carrier assembly 150 poised for coupling to the header housing 110.

During assembly, the header housing 110 is coupled to the panel 20, such as from the front surface 22 of the panel 20. The rear portion 123 is loaded through the panel opening 30. The rear portion 123 is sized and shaped to fit through the panel opening 30. For example, the rear portion 123 is sized and shaped relative to the feed envelope of the panel opening 30 to allow the rear portion 123 to pass through the panel opening 30. For example, the rear portion 123 of the header housing 110 has a housing envelope having a height and a width. The housing envelope is smaller than the panel envelope allowing the rear portion 123 to pass through the panel opening 30. The header housing 110 is moved rearward toward the panel 20 until the mounting flange 134 bottoms out against the front surface 22 of the panel 20. The mounting flange 134 is dimensioned (for example, height and width) larger than the feed envelope of the panel opening 30 in at least one direction (for example, in all four directions in the illustrated embodiment) to bottom out against the panel 20 and not pass through the panel opening 30. The slide lock 140 is then coupled to the rear portion 123 of the header housing 110 to lock the header housing 110 to the panel 20. The slide lock 140 is dimensioned (for example, height and width) larger than the feed envelope of the panel opening 30 in at least one direction to bottom out against the panel 20 and not pass through the panel opening 30. The panel 20 is sandwiched between the mounting flange 134 and the slide lock 140. In an exemplary embodiment, the rear portion 123 extends rearward of the slide lock 140 for connection with the busbar carrier assembly 150.

During assembly, the busbars 180 are loaded into the busbar carrier 160. For example, the busbars 180 may be rear loaded into the busbar channels 166 in the support wall 162. The mating ends 182 of the busbars 180 extend forward of the support wall 162. The busbar carrier 160 holds the busbars 180 relative to each other at proper locations (for example, spacing) for mating with the plug connector 200. The busbar carrier assembly 150 is coupled to the rear portion 123 of the header housing 110. For example, the mating ends 182 of the busbars 180 are rear loaded into the cavity 114 of the header housing 110. The mating ends 182 are loaded to the front of the header housing to mate with the plug connector 200. The mating ends 182 pass through the panel 20, such as to a mating location located forward of the panel 20. The mating ends 182 are arranged at a spacing that fits within the panel envelope. In an exemplary embodiment, the support wall 162 supports the busbars 180 in the cavity 114. For example, the header housing 110 does not directly engage the busbars 180, but rather the busbars 180 are cantilevered into the cavity 114 by the support wall 162 of the busbar carrier 160. The front portion of the support wall 162 may be loaded into the cavity 114. The mounting portion 164 is coupled to the rear portion 123 of the header housing 110. For example, the rear portion 123 may be plugged into the space between the outer wall 172 and the support wall 162. The sections 176 may surround the rear portion 123. The latching features 178 are configured to be latchably coupled to the latches 125 at the rear portion 123 to secure the busbar carrier 160 to the rear portion 123. The busbar carrier 160 is removably coupled to the terminating end 118 of the header housing 110, such as by releasing the latching features 178 from the latches 125. The terminating ends 184 of the busbars 180 extend rearward from the busbar carrier 160. The terminating ends 184 are not loaded into the header housing 110 and thus may have any size and/or shape. The size and shape of the terminating ends 184 are not controlled by the size and shape of the header envelope because the terminating ends 184 do not have to pass through the header housing 110. Additionally, the terminating ends 184 are not loaded through the panel opening 30 and thus may have any size and/or shape. The size and shape of the terminating ends 184 are not controlled by the size and shape of the panel envelope because the terminating ends 184 do not have to pass through the panel opening 30. As such, the terminating ends 184 may be spread outward for connection or termination to the power cables. For example, the terminating ends 184 may be spread out to space the power cables 102 apart from each other for easier termination and/or to prevent electrical arcing therebetween.

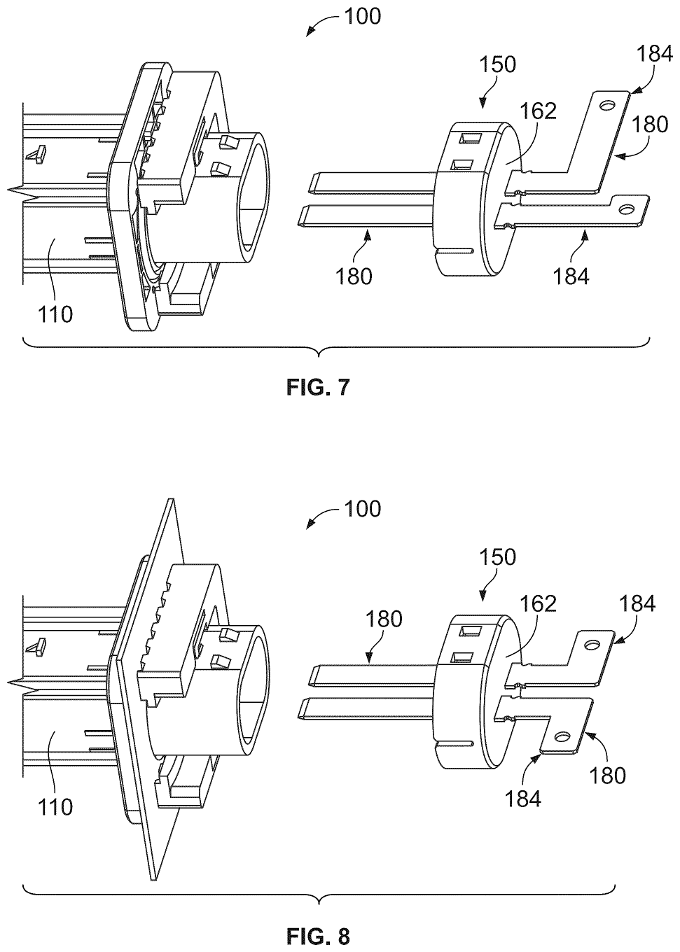

FIG. 7 is a rear perspective view of the header connector 100 in accordance with an exemplary embodiment showing the busbar carrier assembly 150 poised for coupling to the header housing 110. FIG. 7 shows the terminating ends 184 of the busbars 180 having different shapes. For example, the terminating end 184 of one of the busbars 180 extends generally straight back from the support wall 162, whereas the terminating end 184 of the other busbar 180 extends sideways away from the first busbar 180. The power cables 102 may be terminated to the terminating ends 184 at spaced apart locations by extending the busbar 180 to the side away from the center of the busbar carrier assembly 150. The terminating end(s) 184 may be located outside of the housing envelope and/or outside of the panel envelope of the panel opening 30. Being dimensioned larger than the panel envelope in at least one dimension makes it difficult or impossible to load through the panel opening 30 in the assembled state. However, because the busbar carrier assembly 150 may be rear loaded and separately coupled to the header housing 110, the busbar carrier assembly 150 does not have to pass through the panel opening 30 and thus can be dimensioned larger than the panel envelope.

FIG. 8 shows the terminating ends 184 of the busbars 180 having different shapes. For example, the terminating ends 184 of the busbars 180 both extends outward away from each other (for example, to the right and to the left). The power cables 102 may be terminated to the terminating ends 184 at spaced apart locations by extending the busbar 180 to the sides away from the center of the busbar carrier assembly 150. The terminating ends 184 may be located outside of the housing envelope and/or outside of the panel envelope of the panel opening 30. Being dimensioned larger than the panel envelope in at least one dimension makes it difficult or impossible to load through the panel opening 30 in the assembled state. However, because the busbar carrier assembly 150 may be rear loaded and separately coupled to the header housing 110, the busbar carrier assembly 150 does not have to pass through the panel opening 30 and thus can be dimensioned larger than the panel envelope.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. § 112(f), unless and until such claim limitations expressly use the phrase “means for” followed by a statement of function void of further structure.

What is claimed is:

1. A header connector comprising:
a header housing extending between a mating end and a terminating end, the mating end configured to be mated with a plug connector, the header housing having a cavity between the mating end and the terminating end, the header housing having a mounting flange configured to be mounted to a panel;
a busbar carrier assembly including a busbar carrier and a busbar held by the busbar carrier, the busbar carrier having a support wall and a mounting portion, the busbar being coupled to the support wall, the mounting portion being coupled to the terminating end of the header housing, wherein the busbar is received in the cavity of the header housing for mating with the plug connector when the mounting portion of the busbar carrier is coupled to the terminating end of the header housing.

2. The header connector of claim 1, wherein the busbar carrier is latchably coupled to the terminating end of the header housing.

3. The header connector of claim 1, wherein the busbar carrier is separate and discrete from the header housing, the busbar carrier being removably coupled to the terminating end of the header housing.

4. The header connector of claim 1, wherein the mating end is provided at a front of the header housing and the terminating end is provided at a rear of the header housing, the busbar being rear loaded into the cavity at the rear of the header housing when the busbar carrier is coupled to the header housing.

5. The header connector of claim 1, wherein the support wall includes a busbar channel, the busbar received in the busbar channel, a mating end of the busbar extends forward of the support wall and a terminating end of the busbar extends rearward of the support wall.

6. The header connector of claim 1, wherein the header housing has a housing envelope having a height and a width, a terminating end of the busbar extending outside of the header envelope.

7. The header connector of claim 1, wherein the panel has a front surface and a rear surface, the panel including a panel opening between the front surface and the rear surface, the panel opening having a feed envelope, the mounting flange being dimensioned larger than the feed envelope in at least one direction, the busbar having a mating end and a terminating end, the mating end being dimensioned to fit within the feed envelope, the terminating end being dimensioned larger than the feed envelope in at least one direction.

8. The header connector of claim 1, wherein the panel has a front surface and a rear surface, the panel including a panel opening between the front surface and the rear surface, wherein the header housing is configured to be front loaded into the panel opening to position the mounting flange at the front surface of the panel, the busbar carrier assembly being rear loaded into the panel opening to couple the mounting portion to the terminating end of the header housing.

9. The header connector of claim 1, wherein the busbar is a first busbar, the busbar carrier holding a second busbar.

10. The header connector of claim 1, further comprising a slide lock coupled to the header housing, the slide lock positioned relative to the mounting flange to capture the panel between the slide lock and the mounting flange.

11. The header connector of claim 1, wherein the busbar includes a retention barb engaging the support wall to secure the busbar to the busbar carrier.

12. The header connector of claim 1, further comprising a perimeter seal coupled to the header housing, the perimeter seal configured to seal between the header housing and the panel.

13. A header connector comprising:
a header housing extending between a front and a rear, the header housing including a mating end at the front and a terminating end at the rear, the mating end configured to be mated with a plug connector, the header housing having a cavity between the mating end and the terminating end, the header housing having a mounting flange configured to be mounted to a front surface of a panel with a portion of the header housing passing through a panel opening in the panel rearward of a rear surface of the panel;
a busbar carrier assembly including a busbar carrier and a busbar held by the busbar carrier, the busbar carrier having a support wall and a mounting portion, the busbar being coupled to the support wall, the mounting portion being coupled to the terminating end of the header housing rearward of the panel, wherein the busbar is received in the cavity of the header housing for mating with the plug connector when the mounting portion of the busbar carrier is coupled to the terminating end of the header housing.

14. The header connector of claim 13, wherein the busbar carrier is separate and discrete from the header housing, the busbar carrier being removably coupled to the terminating end of the header housing.

15. The header connector of claim 13, wherein the header housing has a housing envelope having a height and a width, a terminating end of the busbar extending outside of the header envelope.

16. The header connector of claim 13, wherein the panel has a front surface and a rear surface, the panel including a panel opening between the front surface and the rear surface, the panel opening having a feed envelope, the mounting flange being dimensioned larger than the feed envelope in at least one direction, the busbar having a mating end and a terminating end, the mating end being dimensioned to fit within the feed envelope, the terminating end being dimensioned larger than the feed envelope in at least one direction.

17. The header connector of claim 13, further comprising a slide lock coupled to the header housing, the slide lock configured to engage the rear surface of the panel, the slide lock positioned relative to the mounting flange to capture the panel between the slide lock and the mounting flange.

18. A header connector for mounting to a panel having a panel opening defining a feed envelope, the header connector comprising:
a header housing extending between a mating end and a terminating end, the mating end configured to be mated with a plug connector, the header housing having a cavity between the mating end and the terminating end, the header housing having a mounting flange configured to be mounted to a panel, the mounting flange being dimensioned larger than the feed envelope in at least one direction;
a busbar carrier assembly including a busbar carrier and a busbar hold by the busbar carrier, the busbar carrier having a support wall and a mounting portion, the mounting portion being coupled to the terminating end of the header housing, the busbar being coupled to the support wall, the busbar having a mating end and a terminating end configured to be terminated to a power cable, the mating end being dimensioned to fit within the feed envelop, the terminating end being dimensioned larger than the feed envelope in at least one direction, wherein the mating end of the busbar is received in the cavity of the header housing for mating with the plug connector when the mounting portion of the busbar carrier is coupled to the terminating end of the header housing.

19. The header connector of claim 18, wherein the busbar carrier is separate and discrete from the header housing, the busbar carrier being removably coupled to the terminating end of the header housing.

20. The header connector of claim 18, wherein the panel has a front surface and a rear surface, wherein the header housing is configured to be front loaded into the panel opening to position the mounting flange at the front surface of the panel, the busbar carrier assembly being rear loaded into the panel opening to couple the mounting portion to the terminating end of the header housing.
